(19) United States
(12) Patent Application Publication
(10) Pub. No.: US 2024/0204606 A1
(43) Pub. Date: Jun. 20, 2024

(54) BEARING SHIELD DEVICE FOR A STATOR DEVICE, STATOR DEVICE FOR AN ELECTRIC MACHINE, ASSOCIATED PRODUCTION METHOD, AND ELECTRIC MACHINE FOR DRIVING A VEHICLE

(71) Applicant: Valeo eAutomotive Germany GmbH, Erlangen (DE)

(72) Inventor: Stefan WOLF, Erlangen (DE)

(73) Assignee: Valeo eAutomotive Germany GmbH, Erlangen (DE)

(21) Appl. No.: 18/541,379

(22) Filed: Dec. 15, 2023

(30) Foreign Application Priority Data
Dec. 16, 2022 (DE) 10 2022 133 606.9

(51) Int. Cl. H02K 5/15; H02K 11/25

(52) U.S. Cl. CPC H02K 5/15; H02K 11/25

(57) ABSTRACT

Bearing shield device for a stator device, having a bearing shield and a sensor device which has a holding member fastened to the bearing shield. The holding member has a first leg portion, a second leg portion, and a web portion connecting the leg portions. The leg portions for arranging the sensor device on a winding head of the stator device are elastically deformable in such a manner that they radially embrace the winding head and exert a restoring force on the latter.

The present invention relates to a bearing shield device for a stator device, having a bearing shield and a sensor device which has a holding member fastened to the bearing shield, wherein the holding member has a first leg portion, a second leg portion, and a web portion connecting the leg portions.

The invention also relates to a stator device for an electric machine, to a method for producing a stator device, and to an electric machine for driving a vehicle.

Known from EP 3 618 242 A1 is an electric motor comprising a stator with a winding head, a bearing shield and a temperature sensing unit. The temperature sensing unit comprises two feet, a transverse element spacing the feet apart, and two temperature sensors which are in each case arranged on one of the feet. The feet bear on the winding head.

During the operation of electric machines the temperature of a winding head of a stator of the electric machine is an important operating parameter that can be taken into account when controlling the electric machine. Typically, in order to detect the temperature, temperature sensors are arranged on the winding head. In the context of fastening the temperature sensor inside the electric machine it is already known to attach the temperature sensor to a holding member and to arrange the latter on the winding head. The holding member is then fastened to a bearing shield of a stator housing.

The invention is based on the object of specifying a production-friendly possibility for temperature measurement on a stator-proximal winding head of an electric machine.

This object is achieved according to the invention in a bearing shield device of the type mentioned at the outset in that the leg portions for arranging the sensor device on a winding head of the stator device are elastically deformable in such a manner that they radially embrace the winding head and exert a restoring force on the latter.

The bearing shield device according to the invention for a stator device has a bearing shield. The bearing shield device furthermore has a sensor device. The sensor device has a holding member. The holding member is fastened to the bearing shield. The at least one temperature sensor is fastened to the holding member. The holding member comprises a first leg portion, a second leg portion, and a web portion. The web portion connects the leg portions. The stator device has a winding head. The leg portions for arranging the sensor device on the winding head are elastically deformable in such a manner that they radially embrace the winding head and exert a restoring force on the winding head.

Due to the elastic deformability of the leg portions, the bearing shield device can be arranged on the winding head during the manufacture of the stator device in such a way that the leg portions are elastically deformed and due to the restoring force press the sensor device onto the winding head. It is advantageous that the bearing shield and the sensor device can be attached to the stator in one operating step, whereby the conventionally provided separate arrangement of the sensor device on the winding head prior to the arrangement of the bearing shield device on the winding head can be dispensed with. This facilitates the manufacture of the stator device and in a certain sense represents a “plug-and-play solution”, because the sensor device including the bearing shield device can be arranged on the winding head.

The bearing shield device according to the invention can be part of a stator housing of the stator device. The stator housing may have a housing casing to which the bearing shield device is fastened. It is preferred here that a stator having the winding head is located in the housing casing and the bearing shield device is routed onto the winding head and in particular covers the housing casing on one side in the process. The stator housing can have a further bearing shield which is able to be arranged or is arranged on the side of the housing casing that lies opposite the bearing shield device. The winding head and/or the housing casing can furthermore have a longitudinal axis along which a shaft of the stator device is able to be arranged. The terms “radial”, “axial” and “in the circumferential direction” refer to this longitudinal axis. The holding member can be made of plastics material or metal, in particular of sheet metal.

The sensor device can have a temperature sensor or a plurality of temperature sensors, as will yet be described further in detail hereunder. The or a respective temperature sensor can have a sensor element and a sensor enclosure receiving the sensor element. The sensor element can also be understood or referred to as a sensor pill. Preferably, the sensor element is an NTC resistor. The or a respective temperature sensor can furthermore have electrical lines which are contacted to the sensor element and/or are received in the sensor enclosure. Preferably, the temperature sensor is fastened to the holding member in such a manner that the sensor element is able to be arranged or is arranged between the leg portion and the winding head. However, it is also conceivable that the sensor enclosure is fastened to the holding member and the sensor element is able to be arranged or is arranged on the winding head so as to be spaced apart from the leg portion.

In a preferred design embodiment of the bearing shield device according to the invention, the leg portions at their ends facing away from the web portion can be widened in a direction pointing away from one another. The winding head is in particular able to be introduced between the ends. The widening of the ends allows for compensation of position tolerances when arranging the bearing shield device on the winding head, because a larger space is provided for receiving the winding head between the ends. Figuratively speaking, the leg portions, or their ends, trap the winding head. With respect to the longitudinal axis of the winding head, one end can be widened radially outwards, and one end can be widened radially inwards.

It is furthermore preferably provided in the bearing shield device according to the invention that the holding member has a spacer. The holding member can be fastened to the bearing shield by way of the spacer. The spacer can furthermore space apart the web portion from the bearing shield. As a result of the spacer, the sensor device can be adapted to different geometric design embodiments of the stator device, since the spacer can compensate for different spacings between the web portion and the bearing shield.

In a preferred embodiment herein it is provided that the spacer has two wing portions, which extend in each case in the direction of the bearing shield while forming a first angle from the web portion, and while forming a second angle form a fastening portion resting on the bearing shield and fastened to the bearing shield. It is preferably provided that the first angle is perpendicular and/or the second angle is perpendicular. The wing portions preferably point in opposite directions.

As an alternative to the spacer, it can be provided that the web portion has a fastening means. The holding member can be fastened to the bearing shield by way of the fastening means. This enables a particularly compact embodiment of the sensor device.

It can be provided here that the web portion has a second fastening means, and the web portion between the first fastening means and the second fastening means is elastically deformable in such a manner that it exerts on the winding head a restoring force acting axially on the latter. The holding member can be fastened to the bearing shield by way of the second fastening means. Due to the restoring force acting axially on the winding head, the holding member is securely arranged on the winding head in the axial direction regardless of manufacturing tolerances.

The or a respective fastening means can be, for example, a screw, a bolt, a rivet, or a spot weld.

In a preferred design embodiment of the bearing shield device according to the invention, it can be provided that the sensor device has a temperature sensor arranged on the web portion. This enables a temperature to be measured at the axial end of the winding head. In the holding member fastened to the bearing shield by means of the fastening means, it can also be provided here that the temperature sensor is arranged between the first fastening means and the second fastening means.

It is preferably provided that the web portion has a convexity which points towards the bearing shield and/or away from the winding head, and into which the temperature sensor arranged on the web portion is introduced.

In the bearing shield device according to the invention, it can also be provided that the sensor device has a temperature sensor arranged on the first leg portion and/or a temperature sensor arranged on the second leg portion. This enables a temperature to be detected on one or both radial lateral faces of the winding head.

It is preferred here that the or each leg portion on which the temperature sensor is arranged, has a convexity which points away from the leg portion opposite thereto and/or from the winding head and into which the temperature sensor arranged on the leg portion is introduced. In this case, the sensor element is preferably arranged in the convexity.

According to an alternative design embodiment, the or each leg portion on which the temperature sensor is arranged has a convexity which lies within the leg portion and points towards the winding head. In particular, it is provided in this case that the sensor element is arranged outside the convexity and/or the sensor enclosure is arranged in the convexity.

The previously described convexities on the leg portion or on the web portion can in each case provide a receptacle space for the temperature sensor and thus, as it were, provide a counter-bearing for the corresponding restoring force. Proceeding from a periphery of the leg portion, or of the web portion, the convexity can extend partially over the width of the leg portion or the web portion, respectively. The temperature sensor herein can have a shoulder, be routed from the periphery through the convexity, and by way of the shoulder impact on the leg portion or web portion, respectively. In this way, a position of the temperature sensor in relation to the holding member can be precisely specified.

The bearing shield can have one or more protrusions to which the sensor device is fastened. The or a respective protrusion can in particular be configured to be dome-like, and/or be engaged with the fastening means and/or the fastening portion.

It can furthermore be provided that the bearing shield has a through-opening and a cover element by way of which the through-opening is able to be opened and closed, and the holding member is fastened to the cover element. This facilitates maintenance and repair of the stator device in the event of a necessary replacement of the sensor device. The leg portions can be removed from the winding head by removing the cover element, thus allowing easy access to the temperature sensors from the outside.

The stator can have a stator core which is formed in particular from a plurality of axially stacked and/or mutually electrically isolated individual laminations. The winding head is preferably formed on an end side of the stator core. The stator can furthermore comprise a stator winding that forms the winding head.

The stator winding can be formed as round wire winding. Alternatively, the stator winding is formed as hair pin winding. The stator winding can be formed by shaped conductors which have in each case two leg portions that penetrate the stator core at different positions in the circumferential direction, and a connecting portion that connects the leg portions on the end side. The leg portions and the connecting portion of a respective shaped conductor can be formed integrally from a metal rod which is made of copper and bent multiple times. Free ends of different shaped conductors on a further end side lying opposite the end side can be electrically conductively and mechanically connected to one another, for example in a materially integral manner.

The object underlying the invention is further achieved by a stator device for an electric machine, having: a stator which has a winding head, and a bearing shield device according to the invention, wherein the leg portions embrace the winding head and exert the restoring force on the latter, and the at least one temperature sensor rests on the winding head.

The object underlying the invention is furthermore achieved by a method for producing a stator device, comprising the following steps: providing a stator which has a winding head; providing a bearing shield device according to the invention; and arranging the bearing shield device on the winding head in such a way that the leg portions embrace the winding head while exerting the restoring force on the latter, and the temperature sensor rests on the winding head.

The stator can be provided so as to be arranged in a housing casing. Alternatively, the method can comprise a step of arranging the stator in a housing casing until the bearing shield device arranged on the winding head reaches the housing casing. In both cases, the method can furthermore comprise a step of fastening the bearing shield device to the housing casing.

The object underlying the invention is furthermore achieved by an electric machine for driving a vehicle, having a stator device according to the invention or a stator device obtained by the method according to the invention, and a rotor which is mounted so as to be rotatable in relation to the stator.

All of the embodiments pertaining to the bearing shield device according to the invention can be applied in an analogous manner to the stator device according to the invention, the method according to the invention and the electric machine according to the invention, so that the advantages described above can also be achieved with these.

Further advantages and details of the present invention are derived from the exemplary embodiments described hereunder and by means of the drawings.

These are schematic illustrations and in:

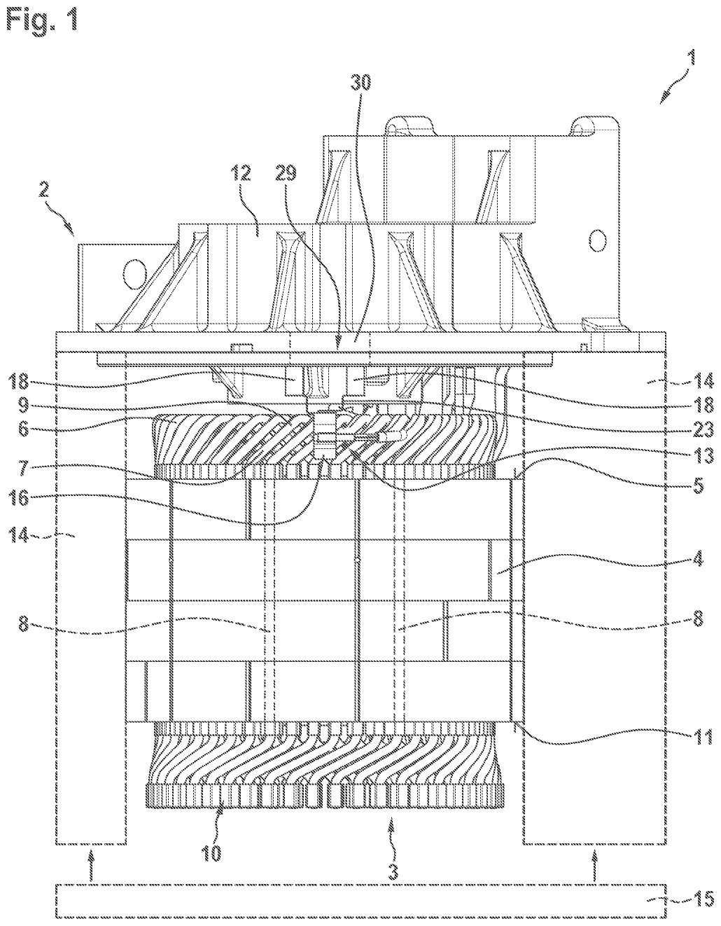

FIG. 1 shows a lateral view of an exemplary embodiment of the stator device according to the invention having a first exemplary embodiment of the bearing shield device according to the invention;

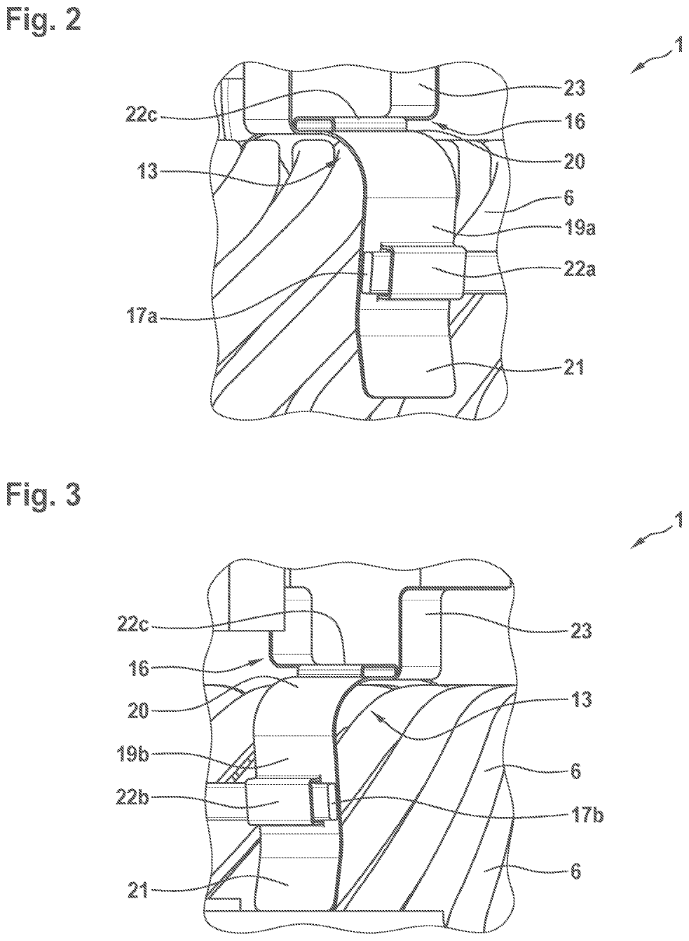

FIGS. 2 and 3 show in each case a perspective view of the stator device according to the first exemplary embodiment in the region of the sensor device bearing on the winding head;

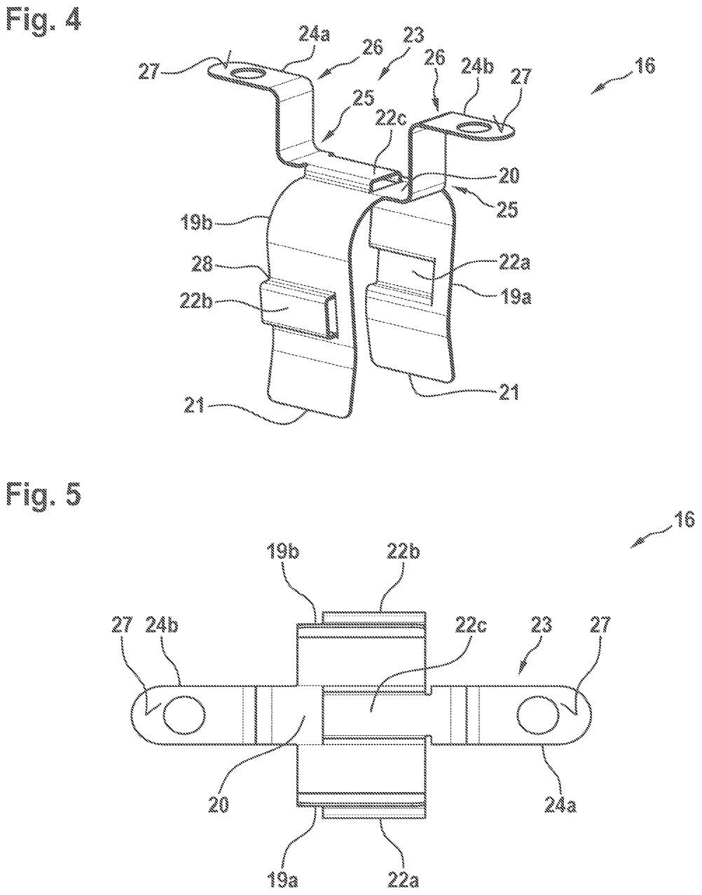

FIG. 4 shows a perspective view of the holding member according to the first exemplary embodiment;

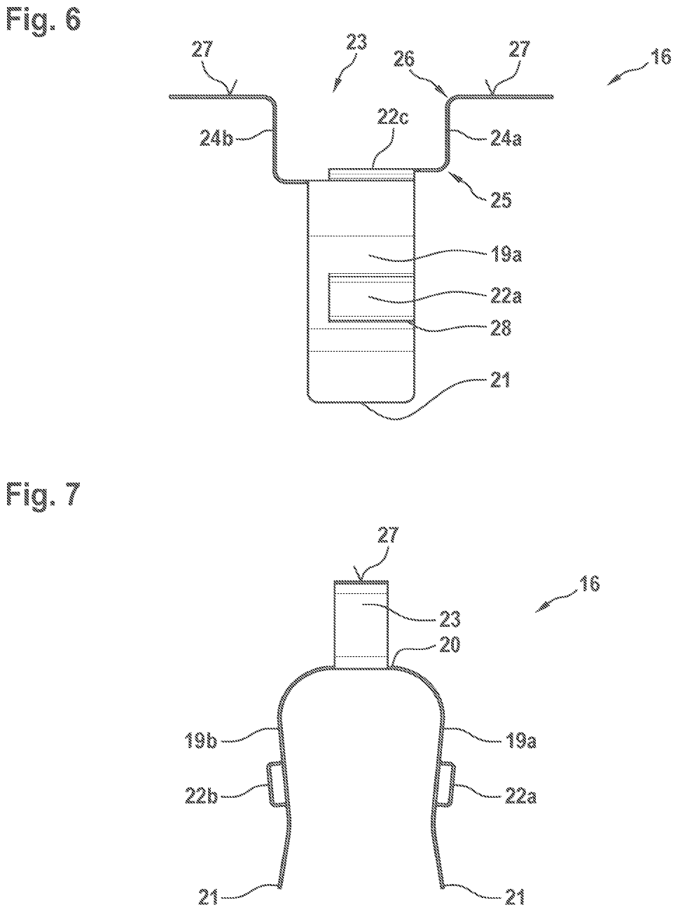

FIGS. 5 to 7 show in each case a lateral view of the holding member according to the first exemplary embodiment;

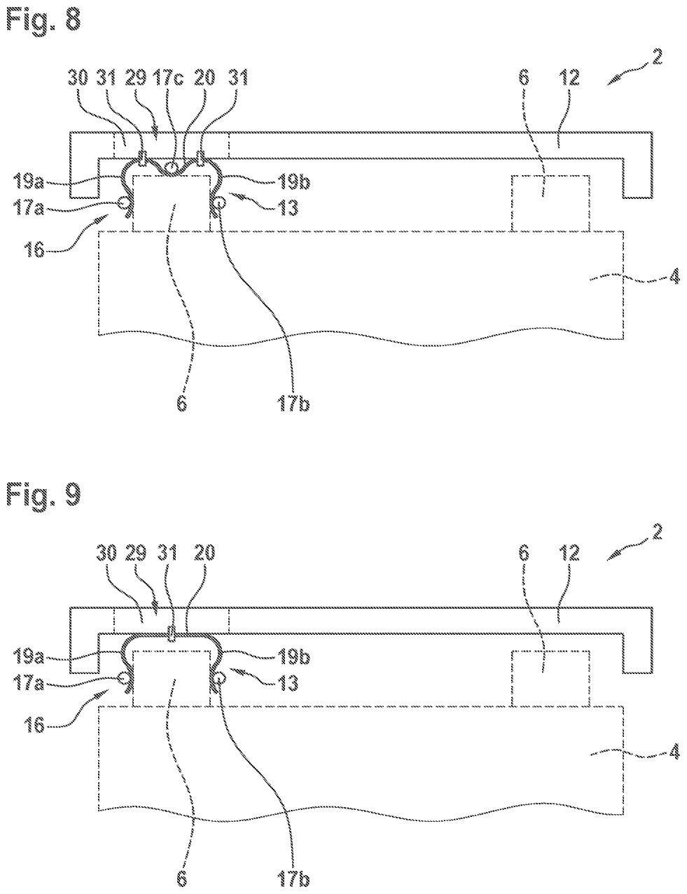

FIGS. 8 and 9 show diagrams of a second and third exemplary embodiment of the bearing shield device according to the invention; and

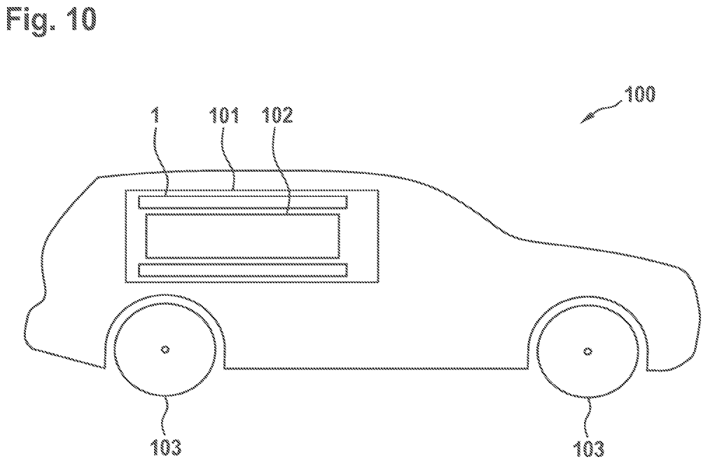

FIG. 10 shows a diagram of a vehicle having an exemplary embodiment of the electric machine according to the invention.

FIG. 1 shows a lateral view of an exemplary embodiment of a stator device 1 having a first exemplary embodiment of a bearing shield device 2a.

The stator device 1 has a stator 3 having a stator core 4 and a stator winding which forms a winding head 6 on an end side 5 of the stator core 4.

By way of example, the stator winding here is formed as hair pin winding. The stator winding herein is formed by shaped conductors 7 which have in each case two leg portions 8 that penetrate the stator core 4 at different positions in the circumferential direction, and a connecting portion 9 that connects the leg portions 8 on the end side 5. The leg portions 8 and the connecting portion 9 of a respective shaped conductor 7 herein are formed integrally from a metal rod which is made of copper and bent multiple times. Free ends 10 of different shaped conductors 7 are connected to one another in an electrically conductive and mechanical manner, for example in a materially integral manner, on a further end side 11 opposite the end side 5. The stator winding can be formed according to alternative exemplary embodiments of the stator device 1 but by a round wire winding.

The stator device 1 furthermore comprises a stator housing 2 comprising the bearing shield device 2a. The bearing shield device 2a comprises a bearing shield 12 and a sensor device 13. In addition, the stator housing 2 comprises a housing casing 2b to which the bearing shield device 2a, or the bearing shield 12, is fastened. Optionally illustrated is another bearing shield 15, which is able to be fastened to the side of the housing casing 2b opposite the bearing shield 12.

The sensor device 13 has a holding member 16 and two temperature sensors 17a, 17b, of which the temperature sensor 17b in FIG. 1 is obscured by the winding head 6. The temperature sensors 17a, 17b are fastened to the holding member 16 which in turn is fastened to the bearing shield 12. For this purpose, the bearing shield 12 has by way of example two dome-like protrusions 18, to which the holding member 16 is fastened by fastening means, such as screws, bolts, rivets or spot welds.

FIG. 2 and FIG. 3 show in each case a perspective view of the stator device 1 according to the first exemplary embodiment in the region of the sensor device 13 which bears on the winding head 6, FIG. 2 showing the sensor device 13 from radially outside and FIG. 3 showing the sensor device 13 from radially inside.

The holding member 16 has a first leg portion 19a, a second leg portion 19b and a web portion 20 connecting the leg portions 19a, 19b. The leg portions 19a, 19b for arranging the temperature sensors 17a, 17b here are elastically deformable in such a manner that they radially embrace the winding head 6 and exert a restoring force on the latter. In order to facilitate the introduction of the winding head 6 into the holding member 16, the leg portions 19a, 19b at their ends 21 facing away from the web portion 20 are widened in a direction pointing away from one another—here in the radial direction. In this way, the winding head 6 can be introduced between the ends 21.

In the present exemplary embodiment, two temperature sensors 17a, 17b which are arranged on the leg portions 19a, 19b are provided. Each leg portion 19a, 19b has a convexity 22a, 22b for this purpose. The convexity 22a of the first leg portion 19a points away from the opposite second leg portion 19b. The convexity 22b points away from the opposite first leg portion 19a. In the received state of the stator 3, the convexities 22a, 22b correspondingly point away from the winding head 6. The temperature sensor 17a is inserted into the convexity 22a. The temperature sensor 17b is inserted into the convexity 22b.

Only a sensor enclosure of the temperature sensor 17a, 17b can be seen in FIG. 2 and FIG. 3. The sensor enclosure accepts a sensor element (not shown), for example a sensor pill formed as an NTC resistor, so that the latter is arranged within the convexity 22a, 22b between the leg portion 19a, 19b and the winding head 6. The temperature sensor 17a, 17b further comprises electrical lines which are received so as to contact to the sensor element in the sensor enclosure.

According to alternative exemplary embodiments of the bearing shield device 2a, which are not shown, the convexities 22a, 22b point towards the winding head 6. In this case, the sensor element is arranged outside the convexity 22a, 22b and in particular only the sensor enclosure is arranged in the convexity.

FIGS. 4 to 7 show in each case the holding member 16 according to the first exemplary embodiment, wherein FIG. 4 is a perspective view and FIGS. 5 to 7 are in each case a lateral view.

In the present exemplary embodiment, the holding member 16 furthermore has a spacer 23. As can be seen in conjunction with FIG. 1, the holding member 16 is fastened to the bearing shield 12 by way of the spacer 23. The spacer 23 herein spaces apart the web portion 20 from the bearing shield 12.

The spacer 23 has two wing portions 24a, 24b, which extend in each case from the web portion 20 in the direction of the bearing shield 12 while forming a first angle 25, and while forming a second angle 26 form a fastening portion 27 resting on the bearing shield 12 and fastened to the bearing shield 12. The angles 25, 26 here are rectangular by way of example. The fastening portion 27 of a respective wing portion 24a, 24b is engaged with the fastening means which fasten the holding member 16 to the protrusions 18 (see FIG. 1).

In addition to the convexities 22a, 22b, a further convexity 22c which points towards the bearing shield 12 or points away from the winding head 6, respectively, is optionally provided on the web portion 20. Although it is not shown in FIG. 1 to FIG. 7, a further temperature sensor can be introduced into the convexity 22c in an analogous manner to the convexities 22a, 22b.

These convexities 22a, 22b, 22c thus provide a receptacle space for a respective temperature sensor 17a, 17b. The convexities 22a, 22b serve here as counter-bearings for the restoring force. The convexities 22a, 22b, 22c extend in each case from a periphery 28 of the leg portion 19a, 19b, or of the web portion 20, partially over the width of the leg portion 19a, 19b, or of the web portion 20, respectively. The respective temperature sensor 17a, 17b has a shoulder here and is routed from the edge 28 through the convexity 22a, 22b, 22c. The shoulder of the temperature sensor 17a, 17b then impacts on the leg portion 19a, 19b, or web portion 20, respectively, so that a position of the temperature sensor 17a, 17b in relation to the holding member 16 is precisely specified.

Optionally, the bearing shield 12 can have a through-opening 29 and a cover element 30, which are schematically indicated in FIG. 1. The cover element 30 is able to be opened and closed by way of the through-opening 29. The holding member here is fastened to the cover element 30. This means that the protrusions 18 are also located on the cover element 30. In the fastened state of the bearing shield device 2a, the cover element 30 can be removed so that the sensor device 13 can be removed from the winding head 6 and removed from the stator housing 2 for maintenance or repair purposes.

Further exemplary embodiments of the bearing shield device 2a, which can be used in an analogous manner in the previously described stator device 1, will be described hereunder. All information pertaining to the first exemplary embodiment can be applied here to the further exemplary embodiments, with the exception of the deviations described hereunder. Identical or functionally equivalent components are provided with identical reference signs.

FIG. 8 shows a diagram of the bearing shield device 2a according to a second exemplary embodiment.

In the second exemplary embodiment, the web portion 20 has two fastening means 31 by way of which the holding member 16 is fastened to the bearing shield 12. This means that no spacer 23 is provided here. The fastening means 31 can be screws, bolts, rivets or spot welds. The web portion 20 is elastically deformable between the fastening means 31 so that it exerts on the winding head 6 a restoring force acting axially on the latter.

In the second exemplary embodiment, three temperature sensors 17a, 17b, 17c are provided, of which the temperature sensors 17a, 17b are arranged on the leg portions 19a, 19b, as in the first exemplary embodiment. The temperature sensor 17c is arranged on the web portion 20 between the fastening means 31 and is pressed onto the winding head 6 by means of the restoring force. For the temperature sensors 17a, 17b, 17c, convexities 22a, 22b, 22c can be provided in an analogous manner to the first exemplary embodiment (see FIGS. 2 to 7).

FIG. 9 shows a diagram of the bearing shield device 2a according to a third exemplary embodiment.

In the third exemplary embodiment, the web portion 20 has a fastening means 31 by way of which the holding member 16 is fastened to the bearing shield 12. This means that no spacer 23 is provided here either. The fastening means 31 can be screws, bolts, rivets or spot welds. Two temperature sensors 17a, 17b which are arranged on the leg portions 19a, 19b are provided, as in the first exemplary embodiment. For the temperature sensors 17a, 19b, convexities 22a, 22b can be provided in an analogous manner to the first exemplary embodiment (see FIGS. 2 to 7). A temperature sensor on the web portion 20 is dispensed with according to the third exemplary embodiment.

Exemplary embodiments of a method for producing a stator device 1 will be described hereunder, wherein reference is made to the preceding descriptions and to FIG. 1 to FIG. 9.

In a step of the method, a stator 3 such as that of the exemplary embodiment of the stator device 1 is provided, wherein the stator 3 is arranged in the housing casing 2b. In a further step, a bearing shield device 2a according to one of the exemplary embodiments described above is provided. This means that the sensor device 13 is already fastened to the bearing shield 12. In a subsequent step, the bearing shield device 2a is arranged on the winding head 6 in such a way that the leg portions 19a, 19b embrace the winding head 6 while exerting the restoring force on the latter, and the temperature sensors 17a, 17b, 17c rest on the winding head. The bearing shield device 2a is then fastened to the housing casing 2b so as to form the stator housing 2.

FIG. 10 shows a schematic diagram of a vehicle 100 having an exemplary embodiment of an electric machine 101.

The electric machine 101, for example a permanently or electrically excited synchronous motor or an asynchronous motor, has a stator device 1 according to one of the exemplary embodiments described above, or a stator device 1 obtained by an exemplary embodiment of the method, and a rotor 102. The rotor 102 is mounted so as to be rotatable in relation to the stator 3 of the stator device 1.

The vehicle 100 furthermore has wheels 103. The electric machine 101 is configured to drive at least one of the wheels 103 indirectly, for example via a gear mechanism (not shown), or to drive same directly, for example in the form of a wheel hub motor. The vehicle 100 can also have an axle (not shown) which is coupled to the wheel 103 and which directly or indirectly drives the electric machine 101 of the vehicle 100.

The vehicle 100 according to the invention is a battery electric vehicle (BEV), a vehicle operated by means of a fuel cell, or a hybrid vehicle. In the latter case, the vehicle 100 also has an internal combustion engine (not shown).

1. Bearing shield device for a stator device, having a bearing shield and a sensor device fastened to the bearing shield, wherein the holding member has a first leg portion, a second leg portion, and a web portion connecting the leg portions,
wherein
the leg portions for arranging the sensor device on a winding head of the stator device are elastically deformable in such a manner that they radially embrace the winding head and exert a restoring force on the latter.

2. Bearing shield device according to claim 1, wherein
the leg portions at their ends facing away from the web portion are widened in a direction pointing away from one another.

3. Bearing shield device according to claim 1, wherein
the holding member has a spacer by which the holding member is fastened to the bearing shield and which spaces apart the web portion from the bearing shield.

4. Bearing shield device according to claim 3, wherein
the spacer has two wing portions, which extend in each case from the web portion in the direction of the bearing shield while forming a first angle, and while forming a second angle form a fastening portion resting on the bearing shield and fastened to the bearing shield.

5. Bearing shield device according to claim 1, wherein
the web portion has a fastening means by way of which the holding member is fastened to the bearing shield.

6. Bearing shield device according to claim 5, wherein
the web portion has a second fastening means by way of which the holding member is fastened to the bearing shield, and the web portion between the first fastening means and the second fastening means is elastically deformable in such a manner that it exerts on the winding head a restoring force acting axially on the latter.

7. Bearing shield device according to claim 1, wherein
the sensor device has a temperature sensor arranged on the web portion.

8. Bearing shield device according to claim 6, wherein
the temperature sensor is arranged between the first fastening means and the second fastening means.

9. Bearing shield device according to claim 7, wherein
the web portion has a convexity which points towards the bearing shield and into which the temperature sensor arranged on the web portion is introduced.

10. Bearing shield device according to claim 1, wherein
the sensor device has a temperature sensor arranged on the first leg portion and/or a temperature sensor arranged on the second leg portion.

11. Bearing shield device according to claim 10, wherein
the or each leg portion on which the temperature sensor is arranged has a convexity which points away from the leg portion opposite thereto and into which the temperature sensor arranged on the leg portion is introduced.

12. Bearing shield device according to claim 1, wherein
the bearing shield has a through-opening and a cover element by way of which the through-opening is able to be opened and closed, and the holding member is fastened to the cover element.

13. Stator device for an electric machine, having:
a stator which has a winding head, and
a stator housing having a housing casing and a bearing shield device according to claim 1 fastened to the housing casing,
wherein the leg portions embrace the winding head and exert the restoring force on the latter, and the at least one temperature sensor rests on the winding head.

14. Method for producing a stator device, comprising the following steps:
providing a stator which has a winding head and is arranged in a housing casing;
providing a bearing shield device according to claim 1;
arranging the bearing shield device on the housing casing in such a way that the leg portions embrace the winding head while exerting the restoring force on the latter, and the temperature sensor rests on the winding head; and
fastening the bearing shield device to the housing casing.

15. Electric machine for driving a vehicle, having
a stator device according to claim 13, and
a rotor which is mounted so as to be rotatable in relation to the stator.

16. Bearing shield device according to claim 2, wherein
the holding member has a spacer by which the holding member is fastened to the bearing shield and which spaces apart the web portion from the bearing shield.

17. Bearing shield device according to claim 2, wherein
the web portion has a fastening means by way of which the holding member is fastened to the bearing shield.

18. Bearing shield device according to claim 2, wherein
the sensor device has a temperature sensor arranged on the web portion (20).

19. Bearing shield device according to claim 7, wherein
the temperature sensor is arranged between the first fastening means and the second fastening means.

20. Bearing shield device according to claim 8, wherein
the web portion has a convexity which points towards the bearing shield and into which the temperature sensor arranged on the web portion is introduced.
